(19) United States
(12) Patent Application Publication
(10) Pub. No.: US 2026/0103344 A1
(43) Pub. Date: Apr. 16, 2026

(54) STRUCTURAL ARRANGEMENT FOR CONVEYOR ROLLERS OF AGRICULTURAL HARVESTING MACHINES AND HARVESTERS

(71) Applicant: CNH Industrial America LLC, New Holland, PA (US)

(72) Inventors: JOÃO AUGUSTO MARCOLIN LUCCA, Sao Pedro (BR); CARLOS EDUARDO DE CARVALHO VISCONTI, São Paulo (BR); GILBERTO JOSÉ RIBERIO ALVES, Piracicaba (BR); DAENIO CLEODOLPHI, Piracicaba (BR); MARCO AURÉLIO RAMOS PEREIRA, Piracicaba (BR)

(21) Appl. No.: 18/720,452

(22) PCT Filed: Dec. 12, 2022
(86) PCT No.: PCT/BR2022/050493

§ 371 Date: Oct. 31, 2025

(30) Foreign Application Priority Data
Dec. 16, 2021 (BR) BR102021025429-7

(51) Int. Cl. B65G 13/11; A01D 45/10

(52) U.S. Cl. CPC B65G 13/11; A01D 45/10; B65G 2207/00

(57) ABSTRACT

A structural arrangement for conveyor rollers of a harvesting machine is mounted on a chassis of a harvester which is formed by side walls. At least one of the side walls has side openings configured to allow the passage of lower and upper conveyor rollers. At least one of the sides of the conveyor rollers is mounted on a substructure which is fitted and fixed on one of the side walls of the chassis.

### FIELD OF THE INVENTION

The present invention relates, in general, to a new structural arrangement for conveyor rollers for agricultural harvesting machines, in particular those intended for harvesting tall and stalky plants, such as sugarcane and sweet sorghum. More particularly, this new structural arrangement of the conveyor roller assembly was designed and developed to simplify production lines, but mainly the maintenance processes of agricultural equipment.

### BACKGROUND OF THE INVENTION

Numerous models of agricultural equipment and machines designed and developed to provide increased yield in the harvesting of different types of vegetable crops are known in the state of the art, for example, grain harvesters, forage harvesters and, also, the so-called harvesting machines of tall and stalky plants, such as sugarcane and sweet sorghum.

The machines intended for harvesting these tall and stalky plants are designed and developed to allow the harvesting of this specific type of crop, because their intrinsic characteristics require specific conditions for their adequate processing, from cutting to transfer to transshipments, buckets and/or trailers.

As must be appreciated by those skilled in the art, these machine models are built on the structure of a chassis responsible for supporting practically all the elements, equipment and devices that enable the operation of these machines. Another important function of the chassis of these harvesting machine models of tall and stalky plants is to accommodate a set of conveyor rollers and chopper rollers that are responsible for guiding and chopping the sugarcane into billets which are transferred to transshipments and/or trailers via an elevator assembly.

Particularly in relation to the structural arrangement that makes up the set of conveyor and chopper rollers, it is formed by the main chassis of the harvesting machine, which is formed by side structures between which the conveyor and chopper rollers are rotatably installed to thus provide the driving and chopping of the harvested material. According to known solutions available in the state of the art, the set of conveyor rollers is basically formed by a series of lower rollers superimposed by a series of upper floating rollers, with the mounting and fixation of these rollers occurring directly on the chassis side structures.

Such mounting of the rollers directly on the side structures of the chassis causes some inconveniences and restrictions, in particular, during the mounting and maintenance processes of the harvesting machines found in the state of the art. More specifically, it is possible to observe that access to the conveyor rollers for eventual maintenance occurs only through the lower part of the chassis, since there are no appropriate accesses in the upper portion or in the sides of these structures to allow a technician to carry out possible maintenance or replacements of the conveyor rollers.

As a result of these limitations, conveyor roller maintenance operations are laborious, complex tasks and require relatively long machine downtimes, considering that, depending on which conveyor roller needs maintenance or replacement, the technician needs to disassemble one or more conveyor rollers to, thereby, access the damaged roller. For example, if one of the damaged rollers is an upper floating roller, the technician will need to disassemble at least one lower roller in order to access and perform maintenance under appropriate conditions. Therefore, as can be seen, the time spent to perform all these tasks interferes directly and negatively with the productivity of the machines during work in the field and, consequently, reduces the profitability of farmers, and it may even result in the loss of part of the harvest due to the machine downtime during any need for maintenance and/or replacement of conveyor rollers.

In this sense, it is observed that the structural arrangements of conveyor rollers known in the prior art reveal solutions that could be improved, particularly with regard to the mounting and maintenance conditions of agricultural machinery in order to provide simpler, more efficient and functional solutions that, in a certain way, are capable of reducing the downtime of machines in situations of maintenance and/or replacement of conveyor rollers.

Hence, it is verified that the prior art machines, especially those intended for harvesting sugarcane and sorghum, present some inconveniences and limitations that can directly affect productivity, considering the complexity of the production, mounting and maintenance processes of the machines, and more particularly with regard to the way of mounting and fixing the set of conveyor rollers to the machine chassis. Therefore, it is desirable to obtain sets of conveyor rollers that have construction arrangements that facilitate access to the rollers for eventual maintenance and/or replacements, thereby reducing the time and costs of machine downtime.

Consequently, these are, among others, the objectives and solutions that are intended to be achieved with the development of the present invention.

### DESCRIPTION OF THE INVENTION

Therefore, in accordance with the above, the present invention aims to provide a new proposal for a structural arrangement for the set of conveyor rollers in harvesting machines for tall and stalky plants, and this new structural arrangement has been designed and developed to offer a practical, functional and efficient solution to the problems, limitations and inconveniences disclosed in the prior art, as mentioned above.

More particularly, it is one of the objectives of the present invention to provide a new structural arrangement of conveyor rollers in harvesting machines for tall and stalky plants, which is formed by technical, constructive and functional characteristics configured to significantly facilitate the manufacturing and maintenance processes of the machines, especially the maintenance procedures for the conveyor rollers, thereby drastically reducing non-productive downtime of the machines.

More objectively, and with the purpose of achieving the technical and functional effects summarized above, among others, the present invention refers to a new structural arrangement for conveyor rollers in harvesting machines, which is mounted on the chassis of an agricultural harvesting machine, and is essentially formed by side walls, at least one of which comprises side openings configured to allow the passage of the lower and upper conveyor rollers, with at least one side of said conveyor rollers being mounted on a substructure which is fitted and fixed to said side wall of the chassis through said side opening.

According to an embodiment of the present invention, said substructure may be configured to cover, at least partially, said side openings.

Moreover, according to another embodiment of the present invention, said upper conveyor rollers can be of the floating type, so that they are mounted on tilting supports installed in the side walls of the chassis by a pivot axis. Optionally, said substructure may comprise a configuration that partially encloses the at least one side of said upper conveyor roller. Alternatively, said substructure may be formed with a configuration which, in the mounted condition, complements the movement opening of the upper and/or floating conveyor roller.

Additionally, according to another possible embodiment of the present invention, said substructures may comprise a plate containing at least one opening that integrally surrounds the at least one side of a non-moving conveyor roller and, further, an open section configured to partially surround the at least one side of the floating conveyor roller.

According to another embodiment of the present invention, said substructures can be configured to provide individual assembly of each conveyor roller. Alternatively, said substructures can be configured for assembling multiple conveyor rollers. Also, according to another particular embodiment of the present invention, said substructure can be configured to support at least one lower conveyor roller and one upper conveyor roller.

Additionally, according to a further particular embodiment of the present invention, said structural arrangement may comprise a movement opening for the floating conveyor roller which is integrally formed on said substructure.

Optionally, according to yet another embodiment of the present invention, said substructure may be configured to support the pivot axis of the tilting support.

Furthermore, according to yet another possible embodiment of the present invention, said side openings arranged in the side walls of the chassis comprise geometric configurations whose formed space is larger than the diameter of the conveyor rollers, and the shape of these side openings may comprise elliptical, triangular, circular, rectangular shapes, or a combination thereof.

Additionally, as mentioned above, the present invention deals with an agricultural harvester of the type for harvesting tall and stalky plants, and which comprises a chassis formed by side walls through which a set of conveyor rollers is mounted, which is formed by a series of lower conveyor rollers and a series of upper conveyor rollers, wherein the agricultural harvester has at least one of said set of conveyor rollers which is being formed by a structural arrangement as defined above.

### BRIEF DESCRIPTION OF THE DRAWINGS

The characteristics, advantages and technical effects of the present invention, as indicated above, will be more adequately understood by a person skilled in the art from the detailed description below, made by way of example only, and not restrictive, and with reference to the schematic figures attached, which:

FIG. 1 is a schematic side view of a harvesting machine known in the art and intended for harvesting tall and stalky plants, such as sugarcane and sorghum;

FIG. 2 shows a perspective view of the chassis section of a harvesting machine with the structural arrangement of the set of conveyor rollers, in accordance with an embodiment of the present invention, in the mounted condition;

FIG. 3A shows a perspective view of the chassis section of a harvesting machine, in accordance with one embodiment of the present invention, without the lower conveyor rollers; and

FIG. 3B shows a perspective view similar to FIG. 3A, but with the conveyor rollers represented outside the chassis of the harvesting machine;

FIG. 4A shows a perspective view of an optional embodiment for mounting the set of conveyor rollers, according to the present invention, in a mounted condition; and

FIG. 4B shows a perspective view similar to FIG. 4A, but with the conveyor rollers represented decoupled from the mounting substructure of the set of conveyor rollers, according to the present invention.

### DESCRIPTION OF THE EMBODIMENTS OF THE INVENTION

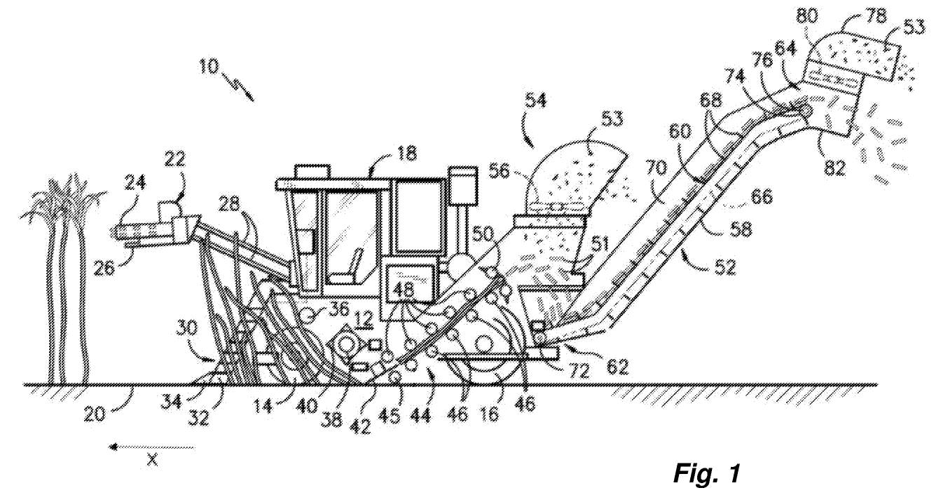

The invention will now be described with respect to its particular embodiments, with reference to the attached figures. Such figures are schematic, and their dimensions and/or proportions may not correspond to reality, as they only aim to describe the invention in a didactic way. Furthermore, certain known and common construction details may have been omitted for greater clarity and conciseness in the description that follows. The reference numbers used are repeated throughout the figures to identify identical or similar parts. The terms eventually used such as “above”, “below”, “front”, “back”, “right”, “left” etc. and its variants must be interpreted according to the guidance given in FIG. 1.

Referring now to the drawings, FIG. 1 illustrates a side view of one embodiment of an agricultural harvester 10 according to aspects known in the state of the art. The harvester 10 is configured as a sugarcane harvester. However, in other embodiments, the harvester 10 may correspond to any suitable agricultural harvester known in the art, such as sorghum and sugarcane harvester.

As shown in FIG. 1, the harvester 10 includes a chassis 12, a pair of front wheels 14, a pair of rear wheels 16, and an operator cabin 18. The harvester 10 may also include a primary power source (e.g., a chassis-mounted engine 12) that powers one or both pairs of wheels 14, 16 via a transmission (not shown). Alternatively, the harvester 10 may be a crawler-actuated 15 harvester and therefore may include crawlers actuated by the drive mechanism in replacement of the illustrated wheels 14, 16. The drive mechanism may also actuate a hydraulic fluid pump (not shown) configured to generate pressurized hydraulic fluid to actuate various hydraulic components of the harvester 10.

Additionally, the harvester 10 may include various components for cutting, processing, cleaning and unloading sugarcane as the sugarcane is harvested from an agricultural field 20. For example, the harvester 10 may include a tip cutter assembly 22 positioned on its front end to intercept the sugarcane as the harvester 10 travels in the forward direction represented by the arrow X. As shown, the tip cutter assembly 22 may include both a gathering disc 24 and a cutting disc 26. The gathering disc 24 can be configured to gather sugarcane stalks together so that the cutting disc 26 can be used to cut off the tip of each stalk. Generally, the height of the tip cutting assembly 22 may be adjustable by means of a pair of arms 28 hydraulically raised, and lowered as desired by the operator.

Additionally, the harvester 10 may include a row divider assembly 30 that extends upward and rearward from the field 20. In general, the row divider assembly 30 may include spiral feed rollers 32, also known as “lollipop”. Each feed roller 32 may include a soil shoe 34 as its lower end assists the row divider assembly 30 in separating sugarcane stalks for harvest. Furthermore, as shown in FIG. 1, the harvester 10 may include a knockdown roller 36 positioned near the front wheels 14 and a roller with protrusions 38 positioned behind the knockdown roller 36. As the knockdown roller 36 is rotated, the harvested sugarcane stalks are tipped over while the row divider assembly 30 gathers the crop stalks of the field 20 toward the interior of the agricultural machine 10. Additionally, as shown in FIG. 1, the roller with protrusions 38 may include a plurality of fins 40 intermittently mounted that assist in forcing the sugarcane stalks downwards. As the roller 38 is rotated during harvesting, the sugarcane stalks that were tipped over by the knockdown roller 36 are separated and subsequently tipped over by the roller 38 as the harvester 10 continues to travel forward with respect to the field 20.

Further referring to FIG. 1, the harvester 10 may also include a base cutting assembly 42 positioned behind the roller 38. As is generally understood, the base cutting assembly 42 may include blades for cutting sugarcane stalks as the cane is harvested. The blades, located at the periphery of the assembly 42, can be rotated by a hydraulic-driven engine, for example, by the hydraulic system of the vehicle. Additionally, in various embodiments, the blades may be angled downward to cut the base of the sugarcane as it is tipped over by the roller 38.

Additionally, the harvester 10 may include a set of one or more conveyor rollers 44 located downstream of the base cutting assembly 42 to move the cut stalks of sugarcane from the base cutting assembly 42 along the processing trajectory. As shown in FIG. 1, a lifting roller 45 is arranged between the base cutting assembly 42 and the conveyor roller assembly 44, the purpose of which is to lift the cut sugarcane from the ground 20 and guide it to the conveyor roller assembly 44 which is formed by a plurality of lower rollers 46 and a plurality of upper rollers 48. As sugarcane is conveyed by the conveyor roller assembly 44, debris (e.g., rocks, dirt and/or similar) can also be conveyed or dropped through the lower rollers 46 onto the field 20.

Additionally, the harvester 10 may include a chopper assembly 50 located at the downstream end of the conveyor roller assembly 44 (e.g., adjacent to the rearmost lower and upper conveyor rollers 46, 48). In general, the chopper assembly 50 can be used to cut or chop harvested sugarcane stalks into smaller pieces or “fragments” 51 that may, for example, measure 15.24 centimeters (six inches), also called billets or stalk sections. The fragments 51 may then be propelled towards an elevator assembly 52 of the harvester 10 to be collected in an external receiver or storage device (not shown).

As is generally understood, pieces of waste 53 (e.g., dust, dirt, leaves, etc.) separated from the sugarcane fragments 51 may be expelled from the harvester 10 through a primary waste extractor assembly 54, which is located behind the chopper assembly 50 and is oriented to direct the waste 53 out of the harvester 10. Additionally, a fan 56 may be mounted on the primary extractor 54 to generate a suction force or vacuum sufficient to capture the waste 53 and force the waste 53 through the primary extractor 54. The waste 53 is then directed out and generally in the opposite direction of the harvester 10 through an outlet of the primary extractor 54. The separated fragments 51 and heavier than the waste 53 being expelled from the extractor 54, can then fall into the elevator assembly 52.

As shown in FIG. 1, the elevator assembly 52 may generally include an elevator housing 58 and an elevator 60 that extends within the elevator housing 58 between a lower proximal end 62 and an upper distal end 64. In general, the elevator 60 may include a chain or conveyor belt 66 and a plurality of paddles or flights 68 coupled to or evenly spaced on the chain 66. The flights 68 may be configured to hold the sugarcane fragments 51 on the elevator 60 as the fragments 51 are lifted towards the top of the elevator 70. Additionally, the elevator 60 may include lower and upper sprockets 72, 74 positioned around the proximal and distal ends 62, 64, respectively. As shown in FIG. 1, an elevator engine 76 may be coupled to one of the sprockets (e.g., the upper sprocket 74) to drive the chain 66, thereby allowing the chain 66 and flights 68 to move in an endless cycle between the proximal and distal ends 62, 64 of the elevator 60.

In addition, pieces of waste 53 (e.g., dust, dirt, leaves, etc.) separated from the sugarcane fragments 51 may be expelled from the harvester 10 through a secondary waste extractor assembly 78 coupled to the rear end of the elevator 58. As shown in FIG. 1, the secondary extractor assembly 78 may be located adjacent the distal end 64 of the elevator 60 and may be oriented to direct waste 53 out of the harvester 10. Additionally, a fan 80 can be mounted on the secondary extractor 78 to generate a suction or vacuum force sufficient to extract the waste 53 and force the waste 53 through the secondary extractor 78. The separated fragments 51, heavier than the waste 53 expelled through the extractor 78, may then fall from the distal end 64 of the elevator 60. Typically, the fragments 51 may fall through a discharge opening 82 of the elevator assembly 52 into an external storage device (not shown), such as a car, a transshipment, a bucket etc.

During work operations, the harvester 10 is driven across the entire agricultural field 20 to harvest sugarcane. Once the height of the tip cutter 22 is adjusted (if used) by means of the arms 28, the gathering disc 24 on the tip cutter assembly 22 may be operated to gather the sugarcane tips together as the harvester 10 travels through the field 20, while the cutting disc 26 cuts the leafy tips of the sugarcane stalks to dump them along both sides of the harvester 10. As the stalks enter the row divider assembly 30, the shoes 34 can configure the operation width to determine the amount of sugarcane entering the harvester input opening 10, either in a fixed or adjustable manner. The lollipops 32 then gather the stalks together at the machine inlet to enable the knockdown roller 36 to bend the stalks down in conjunction with the action of the roller with fins 38. Since the stalks are positioned at an angle as shown in FIG. 1, the base cutting assembly 42 can then cut the base of the stalks of the field 20. The cut stalks are then lifted by the lifting roller 45 and directed to the conveyor roller assembly 44.

The cut sugarcane stalks are conveyed backwards by the conveyor rollers 46, 48 which compress the stalks and harvested matter. At the downstream end of the conveyor roller assembly 44, the chopper assembly 50 cuts or chops the compacted sugarcane stalks into pieces or fragments 51. Conveyed waste 53 (e.g., dust, dirt, leaves, etc.) separated from the sugarcane fragments 51 are then extracted through the primary residue extractor assembly 54 using the suction or vacuum created by the fan 56. The separated/washed fragments 51 then fall onto the elevator assembly 52 and travel upwards by means of the elevator 60 from its proximal end 62 to its distal end 64. During normal operation, once the fragments 51 reach the distal end 64 of the elevator 60, the fragments 51 fall through the discharge opening 82 to an external storage device. Similar to the primary extractor 54, the waste is blown out of the harvester 10 through the secondary waste extractor assembly 78 with the assistance of the fan 80.

A harvester 10, such as the one described above, can be, for example, a machine known in the state of the art, such as the sugarcane harvesters manufactured by CNH Industrial N.V. and sold under the Case IH trademark.

The terms used herein such as harvester, harvesting machine and their variants are used interchangeably to indicate an agricultural machine intended for harvesting a vegetable crop and, in the case of this description, for harvesting tall and stalky plants, such as sugarcane, energy cane, sorghum, etc.

Thus, as represented in the other figures, and in accordance with the present invention, the new structural arrangement for the set of conveyor rollers 44 of harvesting machines for tall and stalky plants 10 is mounted on the chassis 12 which comprises side openings 100 configured to allow the passage of the lower 46 and upper 48 conveyor rollers wherein they are positioned between the side walls 12a of the chassis 12, with at least one of the sides 102 of each conveyor roller 46, 48 being mounted on a substructure 104, which is fitted and mounted in the side wall 12a of the chassis 12 of the harvester 10, so as to cover, at least partially, said side openings 100.

In some models of harvesting machines for tall and stalky plants 10, said upper conveyor rollers 48 are of the floating type and, thus, they are arranged in such a way as to allow their vertical displacement to thereby adjust the space in relation to the lower conveyor rollers 46 as the amount of material being processed by the harvester 10 increases or decreases. In this way, the upper conveyor rollers 48 are mounted on tilting supports 49 that are installed in the side walls 12a of the chassis 12 through a pivot axis 49a. In these cases, where there are floating conveyor rollers, said substructure 104 for mounting the conveyor rollers 46, 48 may comprise a configuration that partially encloses the sides 102 of the floating conveyor rollers.

Further with respect to machine models 10 that comprise floating-type conveyor rollers, said substructure 104 comprises a configuration that, in the mounted condition, complements the movement opening 100a of the floating rollers.

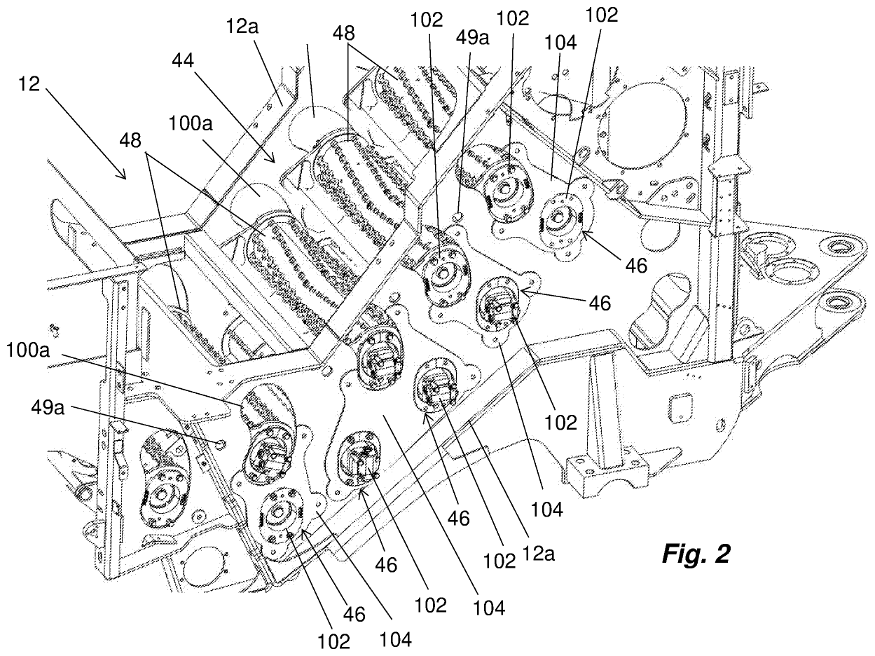

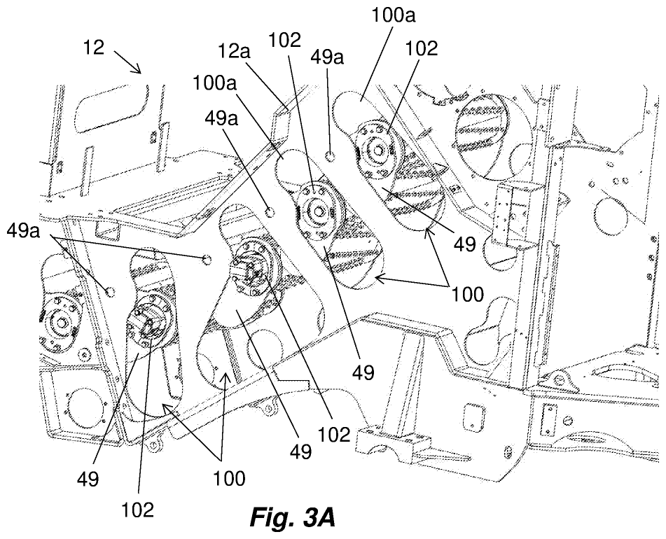

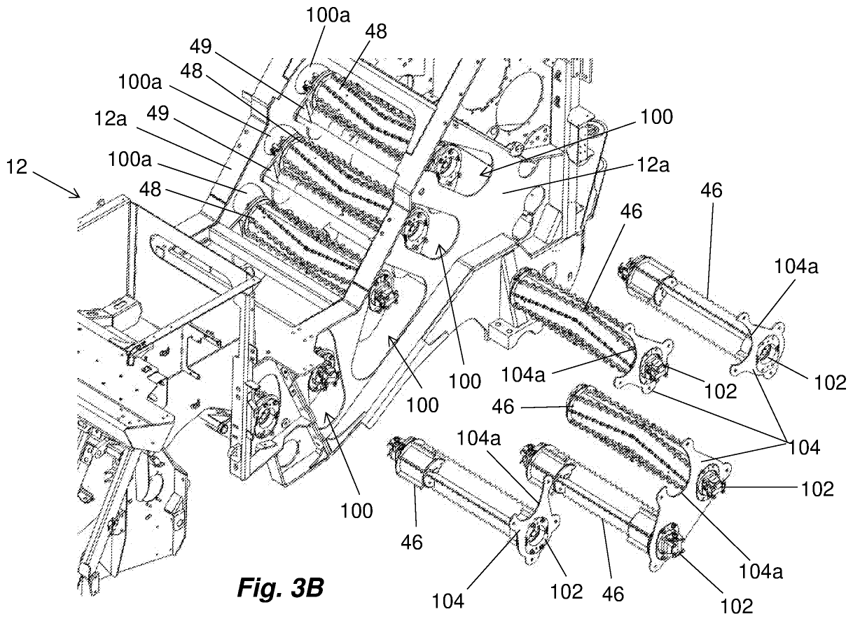

More specifically, according to the embodiment represented in FIGS. 2, 3A and 3B, said substructures 104 may comprise a plate containing at least one opening that integrally surrounds one side 102 of the respective conveyor roller that does not move and, optionally, an open section 104a configured to partially enclose at least one side 102 of the floating conveyor roller, this open section corresponding to a complementary configuration of the movement opening 100a.

It is worth noting that this floating configuration can be applied to the upper rollers 48, as in the embodiment represented in the attached figures, however, as will be appreciated by those skilled in the art, it could also be applied to the lower rollers 46, or to both rollers, or further on only some of the conveyor rollers 46, 48.

Said substructure 104 can be configured for the individual assembly of the conveyor rollers 46, 48, that is, for each conveyor roller 46, 48 a substructure 104 is arranged for mounting next to the side walls 12a of the chassis 12. Optionally, these substructures 104 can be configured for the assembly of multiple conveyor rollers 46, 48, that is, two or more conveyor rollers can be fitted to each substructure 104 which will then be installed in the side walls 12a of the chassis 12.

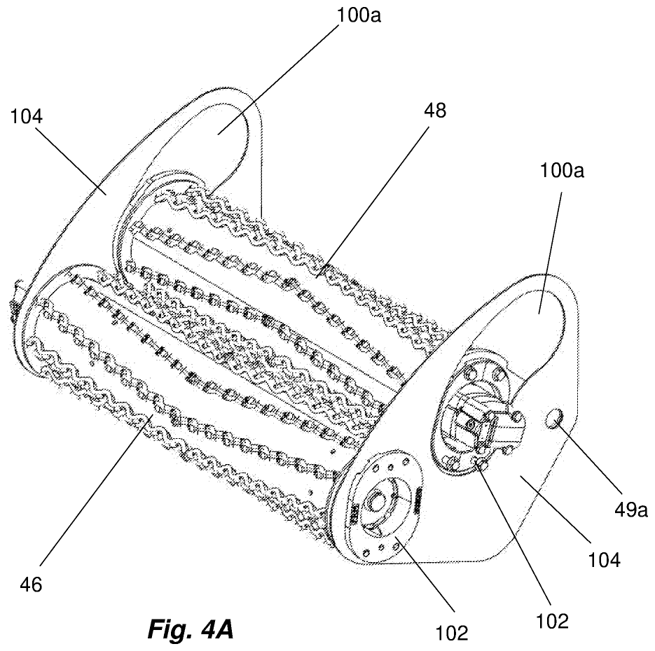

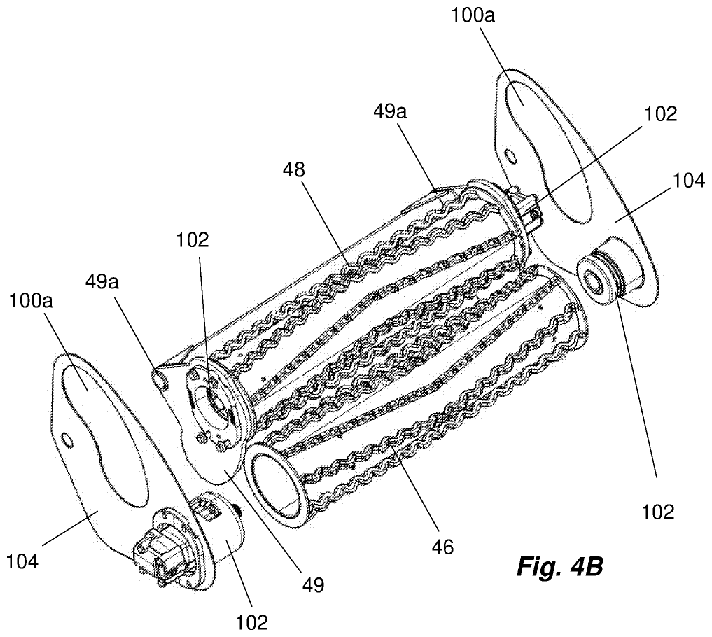

FIGS. 4A and 4B show an embodiment where the substructure 104 is configured to support at least one lower conveyor roller 46 and an upper conveyor roller 48, in which case said movement opening 100a of the floating conveyor roller (in this case, the upper roller 48) is formed integrally on said substructure 104. Likewise, the pivot axis 49a can also, in a particular embodiment, be mounted on said substructure 104.

According to the embodiment represented in FIGS. 4A and 4B, the sides 102 of said conveyor rollers 46, 48 can be previously assembled on the substructure 104 and, when mounting the harvester 10, said rollers 46, 48 can be fitted into one of the side walls 12a of the chassis 12 and, subsequently, the substructure 104 supporting the other side 102 can close the opening 100 while completing the assembly of the sides 102 next to the respective conveyor rollers 46, 48. Optionally, the conveyor rollers of the floating type can be previously mounted on the tilting supports 49, in order to fit the pivot axis 49a and the sides 102 into the movement openings 100a to, in the end, be introduced through the openings 100 of the side wall 12a of the chassis 12.

According to the particular embodiments of the present invention, said side openings 100 provided in the walls 12a of the chassis 12 comprise geometric configurations whose formed space is greater than the diameter of the conveyor rollers 46, 48. Optionally, these side openings 100 may comprise elliptical, triangular, circular, rectangular shapes, or any other defined in the engineering design and suitable for adequate support of the conveyor rollers.

In this context, as can be seen, the new structural arrangement for the set of conveyor rollers 44, according to the present invention, allows the lower and upper conveyor rollers 46, 48 to be assembled and disassembled in a significantly simpler and more effective manner, especially, in cases of maintenance of harvesting machines 10. This is because it is no longer necessary to lift the machines to access the lower part of the rollers, just as it is no longer necessary to disassemble the lower rollers 46 to access the upper rollers from the bottom. Technicians only need to disassemble the substructure 104 corresponding to the conveyor roller 46, 48, which effectively requires maintenance and, thus, making the maintenance process faster, but mainly, reducing the downtime of harvesting machines.

Another advantage obtained by the new structural arrangement for conveyor rollers 44, according to the present invention, is that the conveyor rollers 46, 48 can be previously assembled on their respective substructures 104 so that, when mounting the set of rollers 44 on the chassis 12 of the machine, whether on production lines or during maintenance, technicians can simply fit and install said substructure 104 together with the roller(s) in the openings 100 of the side walls 12a and, if applicable, connect electrical, hydraulic and/or other power supply cables for the proper activation of the active conveyor rollers.

Therefore, it is verified that the new structural arrangement for the set of conveyor rollers 44, object of the present invention, is capable of promoting innovative effects and advantages that are directly related to the technical, constructive and functional aspects resulting in a significant simplification of the manufacturing processes, especially maintenance of conveyor rollers 46, 48 used in harvesting machines for tall and stalky plants. As additional results, it is possible to see a reduction in the downtime of harvesting machines due to maintenance of the conveyor rollers and, consequently, it is possible to obtain improvements involving harvest productivity and farmers profitability.

The present invention also relates to an agricultural harvester, such as a harvester 10 particularly intended for harvesting tall and stalky plants, which comprises, among a series of components, a set of conveyor rollers 44 formed by a structural arrangement as described and defined above.

Finally, considering everything discussed above, it is important to highlight that the present description aims only to present and define by way of example particular embodiments of the new structural arrangement for conveyor rollers of a harvester for tall and stalky plants 10, according to the present invention. Therefore, as those skilled in the art must appreciate, various modifications and combinations of equivalent elements and details are possible without thereby departing from the scope of protection defined by the attached claims.

1. A structural arrangement for an agricultural harvester comprising:
side walls;
conveyor rollers comprising upper conveyor rollers and lower conveyor rollers.
wherein at least one of the side walls comprises side openings configured to allow passage of the lower and upper conveyor rollers; and
wherein at least one side of at least one of the conveyor rollers is mounted on a substructure which is fitted and fixed to at least one of the side walls of the chassis through at least one of the side openings.

2. The structural arrangement according to claim 1, wherein the substructure is configured to cover, at least partially, the at least one of the side openings

3. The structural arrangement according to claim 1, wherein the fact upper conveyor rollers are of the floating type that are mounted on tilting supports installed in the side walls of the chassis by a pivot axis.

4. The structural arrangement according to claim 3, wherein the substructure comprises a configuration that partially surrounds the at least one side of the at least one of the conveyor rollers.

5. The structural arrangement according to claim 3, wherein the substructure comprises a configuration that, in the mounted condition, complements movement opening of the at least one of the conveyor rollers.

6. The structural arrangement according to claim 3, wherein the substructure comprises a plate containing at least one opening that integrally surrounds the at least one side of a conveyor roller that does not move and, further, an open section configured to partially enclose at least one side of the floating conveyor roller.

7. The structural arrangement according to claim 1, wherein the substructure is configured for the individual assembly of each conveyor roller.

8. The structural arrangement according to claim 1, wherein the substructure is configured for the assembly of multiple conveyor rollers.

9. The structural arrangement according to claim 8, wherein the substructure is configured to support at least one lower conveyor roller and one upper conveyor roller.

10. The structural arrangement according to claim 8, wherein substructure comprises a movement opening for the floating conveyor roller that is formed integrally in the substructure.

11. The structural arrangement according to claim 8, wherein the substructure is configured to support the pivot axis of the tilting support.

12. The structural arrangement according to claim 1, wherein the side openings arranged in the side walls of the chassis comprise geometric configurations whose formed space is greater than the diameter of the conveyor rollers.

13. The structural arrangement according to claim 12, wherein the side openings comprise elliptical, triangular, circular, rectangular shapes, or a combination thereof.

14. An agricultural harvester comprising the structural arrangement of claim 1.
